(19) United States
(12) Patent Application Publication
(10) Pub. No.: US 2014/0377981 A1
(43) Pub. Date: Dec. 25, 2014

(54) CABLE BINDING DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIA-BING GAO, Shenzhen (CN); AI-LING HE, Shenzhen (CN); HE FENG, Shenzhen (CN); HAN-BING ZHANG, Shenzhen (CN)

(21) Appl. No.: 13/945,182

(22) Filed: Jul. 18, 2013

(30) Foreign Application Priority Data
Jun. 19, 2013 (CN) 2013102434161

(51) Int. Cl. H01R 12/77

(52) U.S. Cl. CPC H01R 12/772
USPC 439/472

(57) ABSTRACT

A cable binding device for binding cables includes a connector from which the cables extend, a fixing member detachably mounted to the connector, and a binding member pivotably mounted to the fixing member to bind the cables.

### BACKGROUND

1. Technical Field

The present disclosure relates to a cable binding device.

2. Description of Related Art

Connectors for a computer or a server are electrically connected to other components by cables. However, the cables adjacent to the connectors usually need to be manually pressed down or constrained in order for covers or other structures to enclose the components, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a cable binding device with a plurality of cables and a circuit board, wherein the cable binding device includes a fixing member.

FIG. 2 is an enlarged view of the fixing member of FIG. 1.

FIG. 3 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

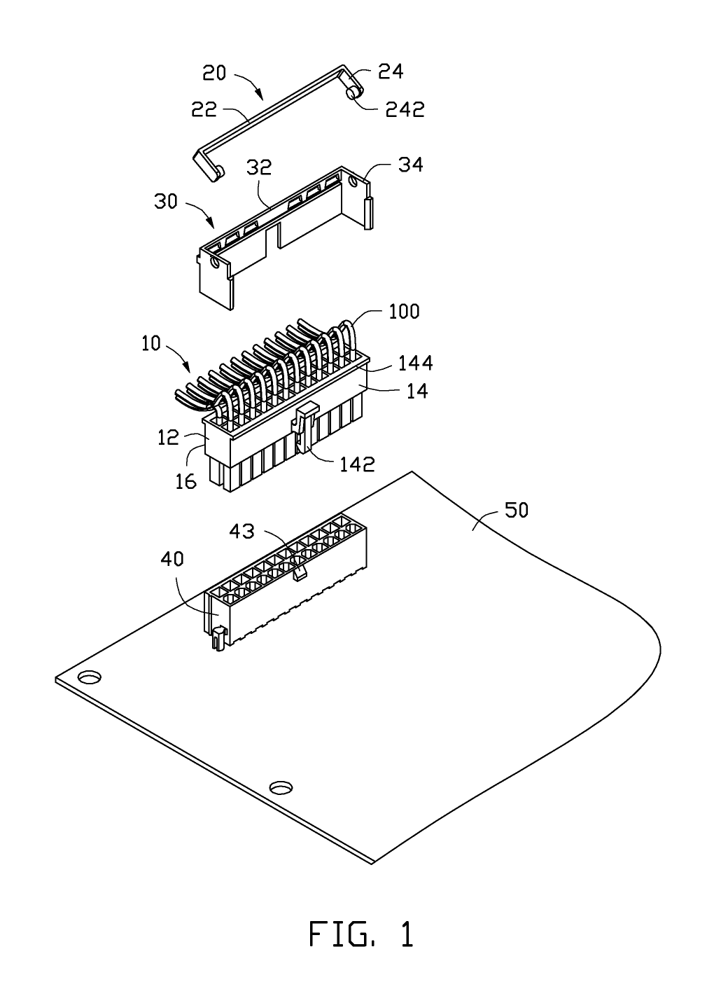

Referring to FIG. 1, an embodiment of a cable binding device is provided for binding cables 100 extending from a connector 10. The cable binding device includes a binding member 20 and a fixing member 30.

The connector 10 is electrically connected to a socket 40 on a circuit board 50. Two wedge-shaped blocks 43 protrude from opposite sides of the socket 40.

The connector 10 includes two opposite end walls 12 and two opposite sidewalls 14 and 16. A hook 142 is mounted to each of the sidewalls 14 and 16 to latch with the blocks 43. A bar 144 protrudes from a top side of each of the sidewalls 14 and 16 and runs along a length of the connector 10.

The binding member 20 includes a pressing portion 22 and two arms 24 extending down from opposite ends of the pressing portion 22. A pin 242 protrudes from an inner surface of a distal end of each arm 24 opposite to the pressing portion 22.

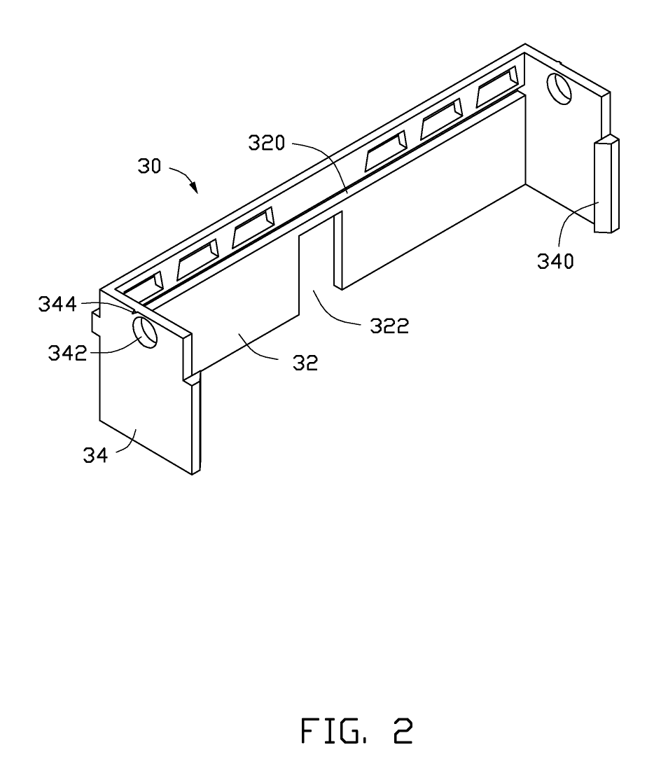

Referring to FIG. 2, the fixing member 30 includes a connecting portion 32 and two extending portions 34 extending substantially perpendicularly from opposite ends of the connecting portion 32. A slot 320 extending along a length of the connecting portion 32 is defined in an inner surface of the connecting portion 32. A receiving hole 322 is defined in a bottom side of the connecting portion 32. A blocking portion 340 protrudes from a distal end of each extending portion 34. Each extending portion 34 defines a through hole 342. A pliable protrusion 344 protrudes from an outer surface of each extending portion 34 between the corresponding through hole 342 and the connecting portion 32.

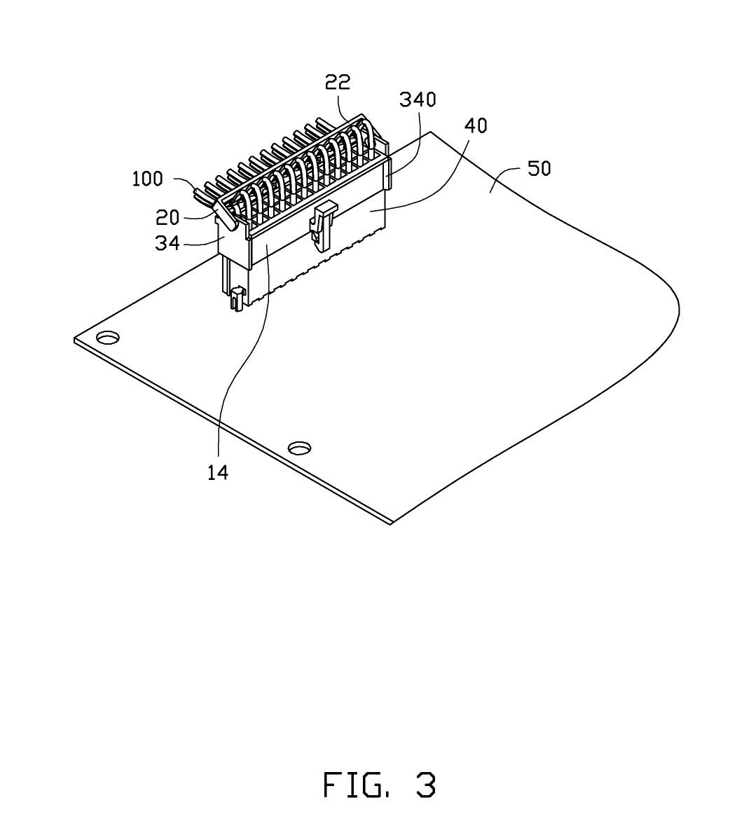

Referring to FIG. 3, in assembly, the arms 24 are bent away from each other to allow the pins 242 to insert into the through holes 342 from outer sides of the extending portions 34, thereby pivotably mounting the binding member 20 to the fixing member 30.

When the cables 100 need to be bent toward the sidewalls 16, the fixing member 30 is mounted to the connector 10 with the connecting portion 32 abutting against the sidewall 16, the extending portions 34 abutting against the end walls 12, and the blocking portions 340 abutting against the sidewall 14. The bar 144 on the sidewall 16 is received in the slot 320, and the hook 142 on the sidewall 16 is received in the receiving hole 322. The binding member 20 is pivoted toward the sidewall 16 to allow the pressing portion 22 to press the cables 100, thereby bending the cables 100 toward the sidewall 16. The arms 24 firmly press against the pliable protrusions, such that the protrusions 344 provide a frictional force to prevent the pressing portion 22 from moving, thereby fixing the binding member 20 to the fixing member 30.

When the cables 100 need to be bent toward the sidewall 14, the fixing member 30 is mounted to the connector 10 with the connecting portion 32 contacting the sidewall 14, thus reversing the fixing member 30.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A cable binding device for binding cables, the cable binding device comprising:
a connector comprising two opposite end walls and two opposite sidewalls connected to the two opposite end walls, each sidewall comprising a bar and a hook, the cables extending from the connector;
a fixing member comprising a slot and a receiving hole, the fixing member being detachably mounted to the connector; and
a binding member pivotably mounted to the fixing member to bind the cables, wherein the slot of the fixing member receives a corresponding bar of the connector, and a corresponding hook protrudes through the receiving hole.

2. The cable binding device of claim 1, wherein the fixing member further comprises a connecting portion to detachably abut against one of the sidewalls of the connector, two extending portions extending substantially perpendicularly from opposite ends of the connecting portion to abut against the end walls of the connector, and two blocking portions protruding from inner surfaces of the extending portions to abut against the other sidewall of the connector.

3. The cable binding device of claim 2, wherein the slot of the fixing member is defined in the connecting portion.

4. The cable binding device of claim 2, wherein the receiving hole of the fixing member is defined in the connecting portion.

5. The cable binding device of claim 2, wherein each extending portion defines a through hole, the binding member comprises a pressing portion, two arms extending substantially perpendicularly from opposite ends of the pressing portion, and a pin protruding from each arm to be pivotably received in a corresponding through hole.

6. The cable binding device of claim 5, wherein the fixing member further comprises a pliable protrusion protruding from an outer surface of each extending portion between the through hole and the connecting portion, the arms resiliently press against the protrusions together to fix the pressing portion to the fixing member when binding the cables.
